(19) United States
(12) Patent Application Publication
(10) Pub. No.: US 2026/0175264 A1
(43) Pub. Date: Jun. 25, 2026

(54) Transmission Apparatus and Cleaning Device

(71) Applicant: Beijing Roborock Technology Co., Ltd., Beijing (CN)

(72) Inventors: Caiyun Hu, Beijing (CN); Lidong Zhao, Beijing (CN)

(21) Appl. No.: 19/539,404

(22) Filed: Feb. 13, 2026

Related U.S. Application Data
(63) Continuation of application No. PCT/CN2024/116956, filed on Sep. 4, 2024.

(30) Foreign Application Priority Data
Aug. 25, 2023 (CN) 202311084862.2

(51) Int. Cl. B08B 1/16; B08B 1/12; B08B 1/34

(52) U.S. Cl. CPC B08B 1/165; B08B 1/12; B08B 1/34

(57) ABSTRACT

A transmission apparatus includes a swing arm and a rotary cleaning unit. One end of the swing arm is rotatably connected to a main body of the cleaning device, the other end is connected to the rotary cleaning unit, and the swing arm is configured to drive the rotary cleaning unit to move between a first position and a second position; an area of at least part of the rotary cleaning unit located outside a projection region of the cleaning device at the second position is larger than an area of at least part of the rotary cleaning unit located outside the projection region of the cleaning device at the first position, and a rotation direction of the swing arm is the same as a rotation direction of the rotary cleaning unit when the rotary cleaning unit moves from the first position towards the second position.

### CROSS-REFERENCE TO RELATED APPLICATION

The present application is a Bypass Continuation application of PCT International Application No. PCT/CN2024/116956, filed on Sep. 4, 2024, which claims priority to Chinese Patent Application No. 202311084862.2, filed on Aug. 25, 2023, both of which are incorporated herein by reference in their entireties for all purposes.

### TECHNICAL FIELD

The present disclosure pertains to the technical field of smart homes, and in particular, relates to a transmission apparatus and a cleaning device.

### BACKGROUND ART

With the iterative updates and advancement of technologies, self-cleaning devices have entered ordinary family life and have gradually become popular.

### SUMMARY OF THE INVENTION

A first aspect of embodiments of the present disclosure provides a transmission apparatus. The transmission apparatus is applied to a cleaning device, and includes a swing arm and a rotary cleaning unit. One end of the swing arm is rotatably connected to a main body of the cleaning device, and the other end of the swing arm is connected to the rotary cleaning unit. The swing arm is configured to drive the rotary cleaning unit to move between a first position and a second position. An area of at least part of the rotary cleaning unit located outside a projection region of the cleaning device when the rotary cleaning unit is located at the second position is larger than an area of at least part of the rotary cleaning unit located outside the projection region of the cleaning device when the rotary cleaning unit is located at the first position, and a rotation direction of the swing arm is the same as a rotation direction of the rotary cleaning unit when the rotary cleaning unit moves from the first position towards the second position.

A second aspect of embodiments of the present disclosure provides a cleaning device. The cleaning device includes a transmission apparatus. The transmission apparatus includes a swing arm and a rotary cleaning unit. One end of the swing arm is rotatably connected to a main body of the cleaning device, and the other end of the swing arm is connected to the rotary cleaning unit. The swing arm is configured to drive the rotary cleaning unit to move between a first position and a second position. An area of at least part of the rotary cleaning unit located outside a projection region of the cleaning device when the rotary cleaning unit is located at the second position is larger than an area of at least part of the rotary cleaning unit located outside the projection region of the cleaning device when the rotary cleaning unit is located at the first position, and a rotation direction of the swing arm is the same as a rotation direction of the rotary cleaning unit when the rotary cleaning unit moves from the first position towards the second position.

### BRIEF DESCRIPTION OF THE DRAWINGS

FIG. 1 is a schematic structural diagram of a cleaning device when a rotary cleaning unit is located at a second position according to one optional embodiment of the present disclosure;

FIG. 2 is a schematic structural diagram of a cleaning device when a rotary cleaning unit moves from a first position towards a second position according to one optional embodiment of the present disclosure;

FIG. 3 is a schematic structural diagram of a swing arm when a rotary cleaning unit is located at a first position according to one optional embodiment of the present disclosure;

FIG. 4 is a schematic structural diagram of a first driving assembly when a rotary cleaning unit is located at a first position according to one optional embodiment of the present disclosure;

FIG. 5 is a schematic structural diagram of a first driving assembly when a rotary cleaning unit is located at a second position according to one optional embodiment of the present disclosure;

FIG. 6 illustrates a schematic structural diagram of the embodiment shown in FIG. 5 from another perspective;

FIG. 7 illustrates a schematic structural diagram of the embodiment shown in FIG. 5 from yet another perspective;

FIG. 8 illustrates a sectional view of the embodiment shown in FIG. 7 in the A-A direction;

FIG. 9 is a schematic structural diagram of a second driving assembly of a rotary cleaning unit according to one optional embodiment of the present disclosure;

FIG. 10 illustrates a schematic structural diagram of the embodiment shown in FIG. 4 from another perspective;

FIG. 11 is a schematic structural diagram of a second housing according to one optional embodiment of the present disclosure;

FIG. 12 illustrates a schematic structural diagram of the embodiment shown in FIG. 11 from another perspective; and

FIG. 13 is a schematic structural diagram when an abutting part is provided with a rolling wheel according to one optional embodiment of the present disclosure.

### DETAILED DESCRIPTION

In the description of the present disclosure, it should be understood that orientational or positional relationships indicated by terms “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, and the like are those shown on the basis of the drawings, and are merely intended to facilitate describing the present disclosure and simplify the description rather than to indicate or imply that the indicated apparatus or element must have a specific orientation and be configured and operated according to the specific orientation. Such relationships are not to be construed as limiting the present disclosure.

In addition, the terms “first” and “second” are merely used for descriptive purposes and are not to be construed as indicating or implying relative importance or implicitly indicating the number of technical features indicated. Thus, features defined by “first” and “second” may explicitly or implicitly include one or more of the features. In the description of the present disclosure, “a plurality of” means two or more, unless otherwise clearly and specifically defined.

In the present disclosure, unless otherwise clearly specified and defined, the terms “mount”, “interconnect”, “connect”, “fix”, and the like should be understood in their broad sense. For example, they may be fixed connection, detachable connection, or integrated connection; they may be mechanical connection or electric connection; they may be direct connection, indirect connection via an intermediate, or internal communication between two elements. For those of ordinary skill in the art, the specific meanings of the aforementioned terms in the present disclosure can be understood according to specific conditions.

A current self-cleaning device has a mopping function. However, the transmission structure in the current self-cleaning device is simple in design and single in function, and can only drive a mopping cloth to rotate for cleaning, such that the position of the mopping cloth is relatively fixed, and the mopping cloth is entirely located below the housing and blocked by the housing in the horizontal direction. Due to the limitation of the housing, the current self-cleaning device cannot clean a surface to be cleaned at a corner, thereby affecting the cleaning effect.

The preferred embodiments of the present disclosure are described below with reference to the drawings. It should be understood that the preferred embodiments described herein are merely intended to illustrate and explain the present disclosure and do not limit the present disclosure.

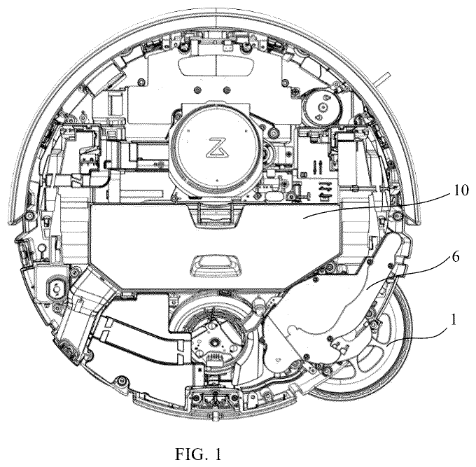

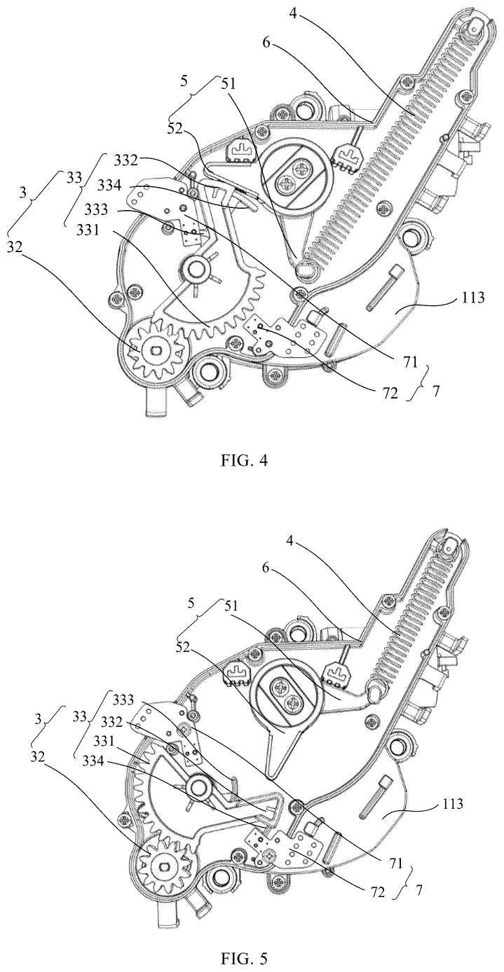

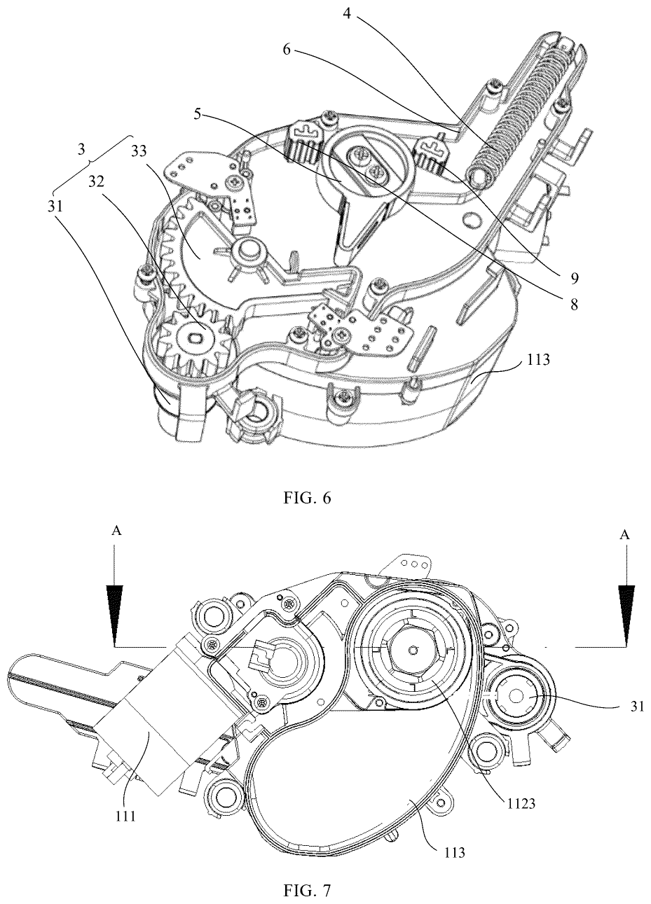

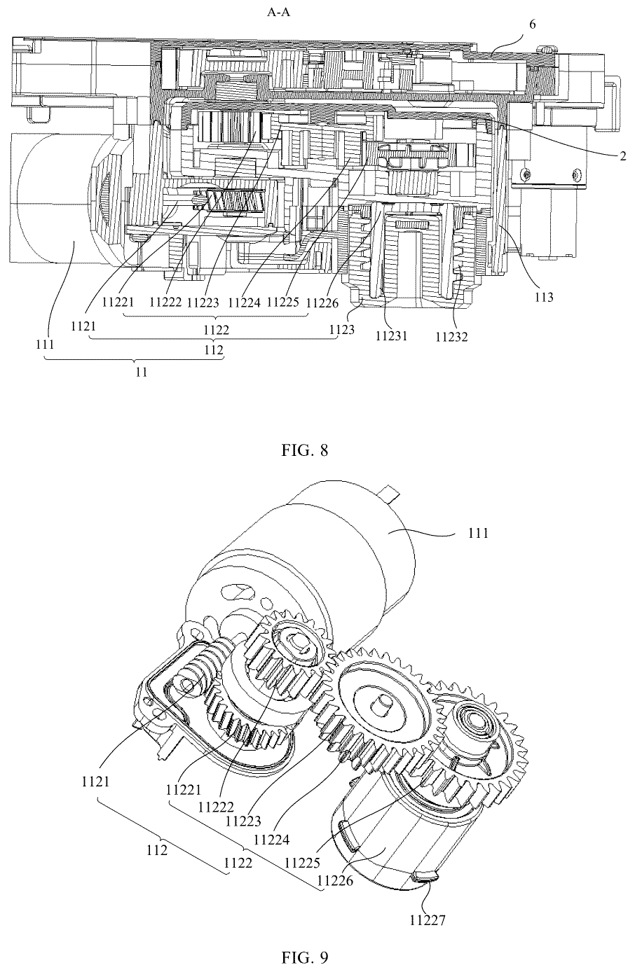

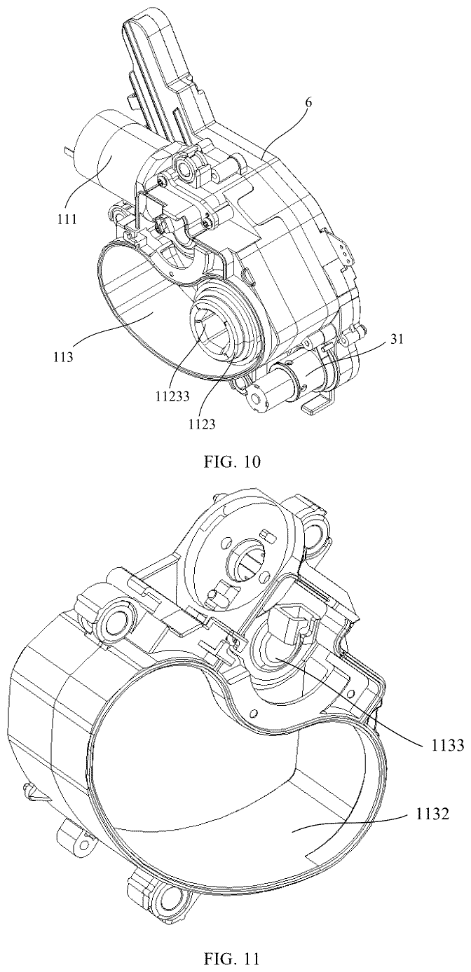

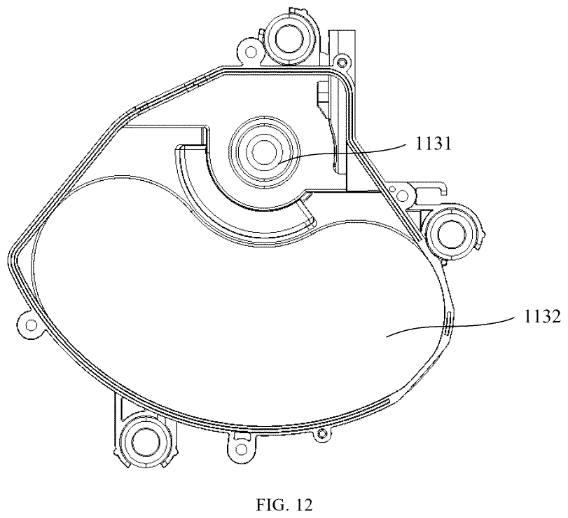

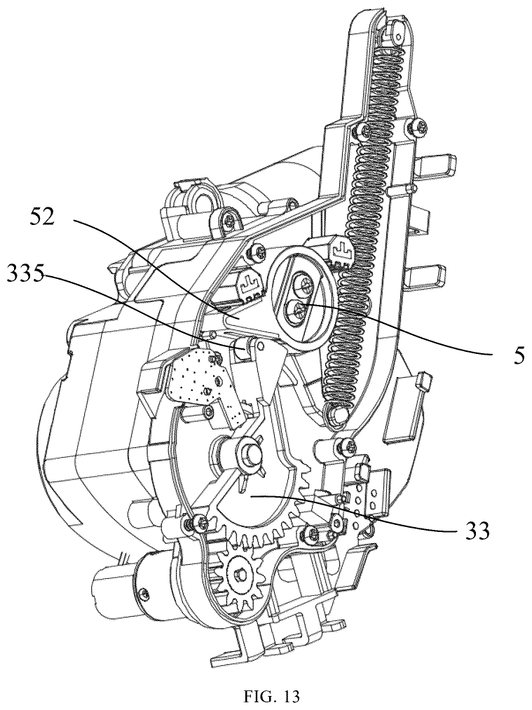

Referring to FIGS. 1 to 13, according to an aspect of the embodiments of the present disclosure, a transmission apparatus is provided, which is applied to a cleaning device 10. The transmission apparatus includes a swing arm 2 and a rotary cleaning unit 1. One end of the swing arm 2 is rotatably connected to a main body of the cleaning device 10, and the other end of the swing arm 2 is connected to the rotary cleaning unit 1. The swing arm 2 is configured to drive the rotary cleaning unit 1 to move between a first position and a second position.

An area of at least part of the rotary cleaning unit 1 located outside a projection region of the cleaning device 10 when the rotary cleaning unit 1 is located at the second position is larger than an area of at least part of the rotary cleaning unit 1 located outside the projection region of the cleaning device 10 when the rotary cleaning unit 1 is located at the first position. When the rotary cleaning unit 1 moves from the first position towards the second position, the rotation direction of the swing arm 2 is the same as the rotation direction of the rotary cleaning unit 1.

One end of the swing arm 2 is rotatably connected to the main body of the cleaning device 10, and the other end of the swing arm 2 is connected to the rotary cleaning unit 1, such that the cleaning device 10 employing the aforementioned transmission apparatus has a mopping disc extending and retracting function. According to a cleaning range requirement, the swing arm 2 is used to drive the rotary cleaning unit 1 to switch between the first position and the second position, so as to move the rotary cleaning unit 1 to an operating position that meets the corresponding cleaning range requirement, such that requirements of different mopping ranges are met and the mopping range is expanded, which is beneficial to improving the cleaning effect, thereby improving the cleaning experience of the user. Meanwhile, when the rotary cleaning unit 1 moves from the first position towards the second position, the rotation direction of the swing arm 2 is the same as the rotation direction of the rotary cleaning unit 1, such that a torque generated due to friction between the rotary cleaning unit 1 and a surface to be cleaned can become an assisting force for the rotary cleaning unit 1 to retract. Therefore, the rotary cleaning unit 1 can be easily retracted passively when being in contact with an obstacle, such that a passive posture change of the cleaning device 10 when the rotary cleaning unit 1 is blocked by the obstacle can be avoided; and thus the cleaning device 10 can perform cleaning tightly against the boundary of the obstacle, such that the cleaning device 10 is able to operate in a complex environment, thereby improving the application range of the cleaning device 10.

The transmission apparatus may be applied to a sweeping robot or other cleaning devices.

The transmission apparatus includes a swing arm 2, and the swing arm 2 is approximately in a strip shape.

The transmission apparatus further includes a rotary cleaning unit 1. The rotary cleaning unit 1 may be a circular mopping disc. The rotary cleaning unit 1 is connected to the cleaning device 10 through the swing arm 2.

In some examples, the swing arm 2 is disposed on one side of the cleaning device 10 that is adjacent to the surface to be cleaned. One end of the swing arm 2 is rotatably connected to the cleaning device 10, and the other end of the swing arm 2 is connected to the rotary cleaning unit 1. The swing arm 2 can rotate by taking a connection point between the swing arm 2 and the cleaning device 10 as a rotation center to drive the rotary cleaning unit 1 to move, so as to adjust the cleaning position of the rotary cleaning unit 1.

The moving position of the rotary cleaning unit 1 includes a first position and a second position.

In some examples, as one embodiment, when the rotary cleaning unit 1 is located at the first position, the rotary cleaning unit 1 is located within the outer edge projection region of the cleaning device 10, and when the rotary cleaning unit 1 is located at the second position, at least part of the rotary cleaning unit 1 is located outside the outer edge projection region of the cleaning device 10. As another embodiment, when the rotary cleaning unit 1 is located at the first position or the second position, at least part of the rotary cleaning unit 1 is located outside the outer edge projection region of the cleaning device 10. However, the area of at least part of the rotary cleaning unit 1 located outside the projection region of the cleaning device 10 when the rotary cleaning unit 1 is located at the second position is larger than the area of at least part of the rotary cleaning unit 1 located outside the projection region of the cleaning device 10 when the rotary cleaning unit 1 is located at the first position.

It can be understood that when the swing arm 2 drives the rotary cleaning unit 1 to move from the first position to the second position, the area of the outer edge projection region of the rotary cleaning unit 1 extending out of the cleaning device 10 increases. In this case, the rotary cleaning unit 1 can clean blind corners on the surface to be cleaned.

In some examples, the rotary cleaning unit 1 may be a self-rotating cleaning element, a vibrating cleaning element, or a fixed cleaning element. In one embodiment of the present disclosure, the rotary cleaning unit 1 may be a mopping disc. The rotary cleaning unit 1 removes stains on the surface to be cleaned through a rotary motion.

The surface to be cleaned may be a bedroom floor or the like. In the present disclosure, one end of the swing arm 2 is rotatably connected to the main body of the cleaning device 10, and the other end of the swing arm 2 is connected to the rotary cleaning unit 1, such that the cleaning device 10 employing the aforementioned transmission apparatus has a mopping disc extending and retracting function, thereby enabling the rotary cleaning unit 1 to extend out to clean blind corners of the bedroom floor.

In a specific application, when the rotary cleaning unit 1 moves from the first position towards the second position, the rotation direction of the swing arm 2 is the same as the rotation direction of the rotary cleaning unit 1, such that the torque generated due to friction between the rotary cleaning unit 1 and the surface to be cleaned becomes an assisting force for the rotary cleaning unit 1 to retract. Therefore, the rotary cleaning unit 1 can be easily retracted passively when being in contact with an obstacle, such that a passive posture change of the cleaning device 10 when the rotary cleaning unit 1 is blocked by the obstacle can be avoided; and thus the cleaning device 10 can perform cleaning tightly against the boundary of the obstacle, such that the cleaning device 10 is able to complete cleaning in a complex environment, thereby improving the application range of the cleaning device 10.

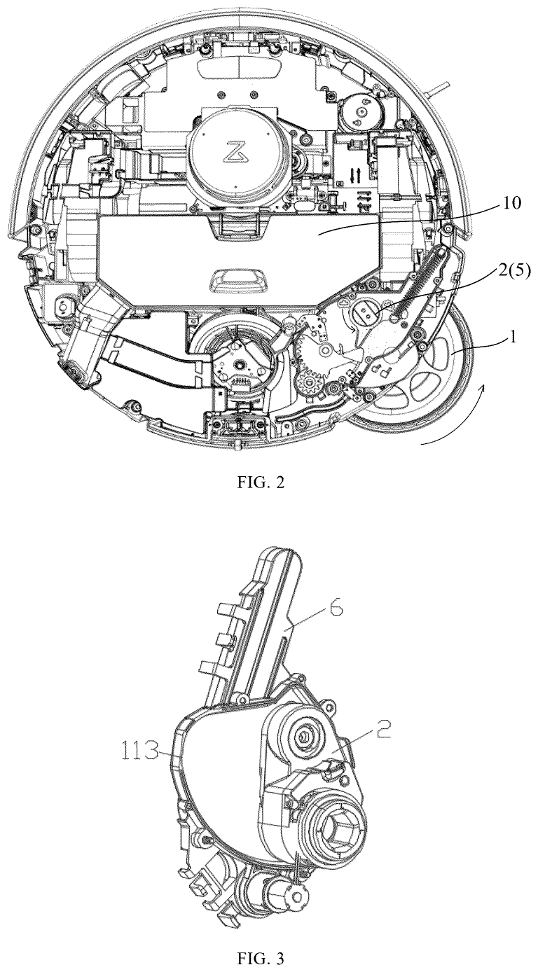

In the above embodiments, as one embodiment, when the swing arm 2 rotates clockwise, the rotary cleaning unit 1 moves from the first position towards the second position. In this case, the rotation direction of the rotary cleaning unit 1 is the same as the rotation direction of the swing arm 2, that is, the rotary cleaning unit 1 also rotates in the clockwise direction. It can be understood that the swing arm 2 needs to rotate in the counterclockwise direction in the case where the rotary cleaning unit 1 is retracted. Since the rotation direction of the rotary cleaning unit 1 is clockwise, in this case, the rotary cleaning unit 1 is in contact with the surface to be cleaned and is subjected to a friction force in the counterclockwise direction, so as to generate a torque in the same direction as the rotation direction of the swing arm 2 when the rotary cleaning unit 1 is in a retracted state. Therefore, the load applied on the swing arm 2 can be reduced, such that the rotary cleaning unit 1 can be retracted more easily, thereby improving the operating stability of the cleaning device 10. As another embodiment, referring to FIG. 2, when the swing arm 2 rotates counterclockwise, the rotary cleaning unit 1 moves from the first position towards the second position. In this case, the rotation direction of the rotary cleaning unit 1 is the same as the rotation direction of the swing arm 2, that is, the rotary cleaning unit 1 also rotates in the counterclockwise direction. It can be understood that the swing arm 2 needs to rotate in the clockwise direction in the case where the rotary cleaning unit 1 is retracted. Since the rotation direction of the rotary cleaning unit 1 is counterclockwise, in this case, the rotary cleaning unit 1 is in contact with the surface to be cleaned and is subjected to a friction force in the clockwise direction, so as to generate a torque in the same direction as the rotation direction of the swing arm 2 when the rotary cleaning unit 1 is in a retracted state. Therefore, the load applied on the swing arm 2 can be reduced, such that the rotary cleaning unit 1 can be retracted more easily, thereby improving the operating stability of the cleaning device 10.

In some examples, in the case where the rotary cleaning unit 1 is in contact with an obstacle, since the rotation direction of the rotary cleaning unit 1 is the same as the rotation direction of the swing arm 2 when the swing arm 2 extends out. In this case, the direction of a resultant force of a reactive force provided by the obstacle to the rotary cleaning unit 1 and a friction force between the rotary cleaning unit 1 and the surface to be cleaned is the same as the rotation direction of the swing arm 2 when the swing arm 2 retracts. Therefore, the load applied on the swing arm 2 can be reduced, such that the rotary cleaning unit 1 can be easily retracted passively when encountering the obstacle. Meanwhile, the rotary cleaning unit 1 can be prevented from being bounced off by the obstacle. The cleaning device 10 can perform cleaning along the edge of the obstacle, such that the cleaning device 10 is able to complete cleaning in a complex environment, thereby improving the application range of the cleaning device 10.

When the rotary cleaning unit 1 is in contact with the obstacle, the reactive force provided by the obstacle to the rotary cleaning unit 1 includes a supporting force exerted by the obstacle on the rotary cleaning unit 1 and a friction force between the obstacle and the rotary cleaning unit 1.

The swing arm 2 can be driven by a motor to rotate. In the case where the rotation direction of the swing arm 2 is the same as the rotation direction of the rotary cleaning unit 1, when the motor drives the swing arm 2 to rotate to cause the rotary cleaning unit 1 to retract, a torque generated by the friction force between the rotary cleaning unit 1 and the surface to be cleaned and the reactive force provided by the obstacle is an assisting force. Therefore, the load overcome by the motor is reduced, and the operating stability of the motor is improved, thereby prolonging the service life of the motor.

In some examples, when the cleaning device 10 is operating, the rotary cleaning unit 1 can be easily retracted when being in contact with an obstacle. In this case, the torque generated by the supporting force and the friction force exerted by the obstacle on the rotary cleaning unit 1 as well as the torque generated by the friction force between the rotary cleaning unit 1 and the surface to be cleaned all serve as assisting force for operation of the motor, so as to avoid an overcurrent in the motor due to resistance applied to the rotating rotary cleaning unit 1, thereby improving the mechanical performance of the motor and the rotating component and prolonging the service life. Meanwhile, the rotary cleaning unit 1 can be easily retracted passively when encountering the obstacle, which can avoid a passive posture change of the entire cleaning device 10 due to the rotary cleaning unit 1 being blocked by the obstacle. For example, when the cleaning device 10 turns along the wall, the cleaning device 10 can be prevented from being pushed away by the wall, and meanwhile, the rotary cleaning unit 1 is passively retracted, without the need for the motor to frequently and actively drive the swing arm 2 to rotate, thereby improving the mechanical performance and service lives of the motor and related transmission members, and thus reducing the cost.

In some embodiments provided by the present disclosure, the transmission apparatus further includes a first driving assembly 3. The first driving assembly 3 may be connected to the swing arm 2 to drive the swing arm 2 to rotate, thereby driving the rotary cleaning unit 1 to move between the first position and the second position. Since the surface to be cleaned is generally a planar structure, during a process in which the rotary cleaning unit 1 at the first position or the second position performs a mopping operation on the surface to be cleaned, in the process of driving the rotary cleaning unit 1 to correspondingly move towards the second position or the first position by using the first driving assembly 3, the rotary cleaning unit 1 can still perform the mopping operation, without switching the operation position after stopping the cleaning operation, and it can be ensured that the rotary cleaning unit 1 after switching the operation position can be reliably in contact with the surface to be cleaned, thereby ensuring a good cleaning effect, while simplifying the control procedure, and improving the cleaning efficiency.

In some examples, at least part of the rotary cleaning unit 1 at the second position is located outside the edge projection region of the cleaning device 10, such that the cleaning range of the rotary cleaning unit 1 at the second position can extend beyond the edge of the traveling range of the cleaning device 10, thereby enabling comprehensive cleaning of edge and corner areas that the cleaning device 10 cannot reach. This improves the cleaning range of the rotary cleaning unit 1, thereby improving the cleaning effect of the cleaning device 10.

The rotary cleaning unit 1 at the second position may be entirely located outside the edge projection region of the cleaning device 10, or may be partially located outside the edge projection region of the cleaning device 10, which may be set according to the specific structure.

The rotary cleaning unit 1 at the first position may be located within the edge projection region of the cleaning device 10, such that the cleaning range of the rotary cleaning unit 1 at the first position can be located within the travel range of the cleaning device 10. Therefore, a mopping operation can be performed on a region within the travel range of the cleaning device 10, such that the possibility that the rotary cleaning unit 1 protrudes out of the cleaning device 10 and collides with an obstacle can be reduced, which is beneficial to improving the service life and reliability of the rotary cleaning unit 1.

The rotary cleaning unit 1 may be selectively driven to switch between the first position and the second position based on whether mopping of edge and corner areas is required. For example, the rotary cleaning unit 1 is moved to the first position to perform a conventional wet cleaning operation, and the rotary cleaning unit 1 is moved to the second position to perform an edge and corner wet cleaning operation, thereby satisfying different functional requirements of the cleaning device 10 and improving the intelligence of the cleaning device 10.

In some embodiments provided by the present disclosure, during a process in which the rotary cleaning unit 1 switches between the first position and the second position, the first driving assembly 3 abuts against the swing arm 2 to cause the swing arm 2 to rotate, which ensures that the swing arm 2 is stably driven to rotate, thereby ensuring that the rotary cleaning unit 1 can stably switch between the first position and the second position.

The first driving assembly 3 may directly abut against the swing arm 2, thereby directly driving the swing arm 2 to rotate through the rotation of the first driving assembly 3.

In some examples, the first driving assembly 3 may include a cam or other eccentric rotary mechanisms. The cam or other eccentric rotary mechanisms abut against the outer wall of the swing arm 2, thereby directly pushing the swing arm 2 to rotate by driving the cam or other eccentric rotary mechanisms to self-rotate.

In some embodiments provided by the present disclosure, one end of the swing arm 2 is connected to a first cam 5, and the other end of the swing arm 2 is connected to the rotary cleaning unit 1. During the process in which the rotary cleaning unit 1 switches between the first position and the second position, the first driving assembly 3 abuts against a protruding part 52 of the first cam 5 to cause the swing arm 2 to rotate.

In some embodiments provided by the present disclosure, the first driving assembly 3 includes a telescopic driving member 31 and a second cam 33. The telescopic driving member 31 is connected to the second cam 33 and is configured to drive the second cam 33 to rotate. The second cam 33 abuts against the first cam 5. The first driving assembly 3 further includes a transmission gear 32. The transmission gear 32 is sleeved on an output end of the telescopic driving member 31. The transmission gear 32 is engaged with the second cam 33.

The second cam 33 includes a sector gear part 331 and an abutting part 332. The transmission gear 32 is drivingly connected to the telescopic driving member 31 and is engaged with the sector gear part 331. The abutting part 332 abuts against the first cam 5. The first cam 5 is coaxially arranged with the swing arm 2.

The sector gear part 331 and the abutting part 332 are spaced apart from each other in the circumferential direction of the rotation shaft of the second cam 33, such that the second cam 33 rotates, and can simultaneously drive the sector gear part 331 and the abutting part 332 to rotate. Therefore, the telescopic driving member 31 rotates in one direction (for example, clockwise or counterclockwise) to drive the transmission gear 32 to rotate. Since the sector gear part 331 is engaged with the transmission gear 32, the sector gear part 331 can drive the second cam 33 to rotate, thereby driving the abutting part 332 to rotate. The abutting part 332 abuts against the first cam 5, and can push the first cam 5 to rotate. Since the first cam 5 is coaxially arranged with the swing arm 2, the swing arm 2 can rotate synchronously with the first cam 5, thereby driving the rotary cleaning unit 1 mounted within the swing arm 2 to move from the second position towards the first position.

In the above embodiments, the transmission apparatus further includes an elastic member 4. One end of the elastic member 4 is connected to the swing arm 2, and the other end of the elastic member 4 is relatively fixedly connected to the main body of the cleaning device 10. Under the action of the elastic member 4, the first driving assembly 3 drives, through the swing arm 2, the rotary cleaning unit 1 to move between the first position and the second position. When the rotary cleaning unit 1 moves from the second position towards the first position, the elastic member 4 accumulates elastic potential energy under the driving of the first driving assembly 3. When the rotary cleaning unit 1 moves from the first position towards the second position, the elastic potential energy of the elastic member 4 is released. When the telescopic driving member 31 rotates in another direction (for example, counterclockwise or clockwise) to drive the transmission gear 32 to rotate, since the sector gear part 331 is engaged with the transmission gear 32, the sector gear part 331 can drive the second cam 33 to rotate, thereby driving the abutting part 332 to rotate. It can be understood that, in this case, the rotation direction of the abutting part 332 is opposite to the rotation direction of the abutting part 332 during the process in which the rotary cleaning unit 1 moves towards the direction of retracting back to the main body of the cleaning device 10. In this case, under the action of the elastic member 4, the first cam 5 rotates reversely relative to the first cam 5 during the process in which the rotary cleaning unit 1 moves towards the direction of retracting back to the main body of the cleaning device 10. Since the first cam 5 is coaxially arranged with the swing arm 2, the swing arm 2 can rotate synchronously with the first cam 5, thereby driving the rotary cleaning unit 1 mounted within the swing arm 2 to move from the first position towards the second position.

Therefore, through cooperation of the telescopic driving member 31, the transmission gear 32, the second cam 33, the first cam 5, and the elastic member 4, the swing arm 2 can rotate in different directions, thereby achieving the switching operation of the rotary cleaning unit 1 between the first position and the second position. This results in a simple structure and a convenient operation.

In some examples, in one embodiment of the present disclosure, when the rotary cleaning unit 1 is located at the first position, the first cam 5 abuts against the second cam 33, and the elastic member 4 is in a stretched state; and when the rotary cleaning unit 1 is located at the second position, the first cam 5 is separated from the second cam 33, and the elastic member 4 is restored to an original state.

In the above embodiments, the circumferential side of the first cam 5 is provided with the protruding part 52 and a connecting part 51. The connecting part 51 is configured to be connected to the elastic member 4. The abutting part 332 is located between the protruding part 52 and the connecting part 51 and is configured to abut against the protruding part 52.

The protruding part 52 and the connecting part 51 are spaced apart from each other on the circumferential side of the first cam 5, such that the rotation of the protruding part 52 can drive the first cam 5 and the connecting part 51 to rotate synchronously. The abutting part 332 of the second cam 33 is disposed between the protruding part 52 and the connecting part 51, such that the second cam 33, when moving in one direction (for example, clockwise or counterclockwise), allows the abutting part 332 to smoothly abut against the protruding part 52, so as to push the first cam 5 to rotate, thereby driving the swing arm 2 to drive the rotary cleaning unit 1 to move towards the first position. Meanwhile, during a process in which the second cam 33 moves in another direction (for example, counterclockwise or clockwise), the abutting part 332 moves in a reverse direction to cancel the pushing force applied to the protruding part 52, and the first cam 5 is separated from the second cam 33. In this case, under the action of the elastic member 4, the first cam 5 is subjected to an elastic force of the elastic member 4 restoring to the original state, that is, the elastic member 4 can pull the first cam 5 to rotate, thereby driving the swing arm 2 to drive the rotary cleaning unit 1 to move towards the second position.

It can be understood that, a first end of the elastic member 4 is connected to the first cam 5, or the first end of the elastic member 4 may also be connected to the swing arm 2, or the first end of the elastic member 4 may also be connected to both the first cam 5 and the swing arm 2.

In this embodiment, the elastic member 4 is exemplified as a tension spring. One end of the elastic member 4 may be fixedly connected, indirectly or directly, to the main body of the cleaning device 10. That is, one end of the elastic member 4 is ensured to be relatively stationary with the main body of the cleaning device 10. The other end of the elastic member 4 may be separately connected to the first cam 5, or may be connected to the swing arm 2, or may be connected to both the first cam 5 and the swing arm 2. For example, the elastic member 4 is of a Y-shaped structure, such that the elastic member 4 can be connected to both the first cam 5 and the swing arm 2. Alternatively, the elastic member 4 can be connected to both the first cam 5 and the swing arm 2 through the connecting part 51 such as a connecting wire.

In some embodiments provided by the present disclosure, the elastic member 4 is a tension spring. A first end of the tension spring is connected to the protruding part 52 of the first cam 5, and a second end of the tension spring is fixed relative to the main body of the cleaning device 10.

Since the elastic member 4 is a tension spring, and the first end of the tension spring is connected to the protruding part 52 of the first cam 5, and the second end of the tension spring is fixed relative to the main body of the cleaning device 10, an elastic force can be stably provided, such that the rotary cleaning unit 1 can switch from the second position towards the first position.

In some embodiments provided by the present disclosure, the elastic member 4 is a torsion spring. The torsion spring is disposed at the rotation shaft of the first cam 5.

The torsion spring may be coaxially arranged with the rotation shaft of the first cam 5. That is, the torsion spring may be sleeved on the outer circumferential side of the rotation shaft of the first cam 5, and one end of the torsion spring is connected to the protruding part 52 of the first cam 5, and a second end of the torsion spring is fixed relative to the main body of the cleaning device 10, which can also stably provide an elastic force, such that the rotary cleaning unit 1 can switch from the second position towards the first position.

In some embodiments provided by the present disclosure, the elastic member 4 is an elastic plate. A first end of the elastic plate is connected to the protruding part 52 of the first cam 5, and a second end of the elastic plate is fixed relative to the main body of the cleaning device 10.

Since the first end of the elastic plate is connected to the protruding part 52 of the first cam 5, and the second end of the elastic plate is fixed relative to the main body of the cleaning device 10, the rotary cleaning unit 1 can be stably driven, by the elastic force generated after deformation, to switch from the second position towards the first position.

It can be understood that the elastic member 4 may also be an elastic component other than the tension spring, the torsion spring, and the elastic plate as long as the elastic member 4 can provide an elastic force to enable the rotary cleaning unit 1 to switch from the first position towards the second position.

In some embodiments provided by the present disclosure, outer walls of the first cam 5 and the second cam 33 are provided with wear-resistant layers, which can reduce the friction force when the first cam 5 and the second cam 33 abut against each other and protect the first cam 5 and the second cam 33, thereby prolonging the service lives of the first cam 5 and the second cam 33 while facilitating driving the swing arm 2 to rotate.

The wear-resistant layer may be a metal sheet, or may be replaced with another wear-resistant material, including but not limited to PK and powder metallurgy materials, to avoid wear of the first cam 5 and the second cam 33.

In some embodiments provided by the present disclosure, the abutting part 332 of the first cam 5 is provided with a rolling wheel 335, and the first cam 5 abuts against the first driving assembly 3 via the rolling wheel 335, such that rolling friction is formed between the protruding part 52 and the first driving assembly 3 with a relatively small friction force, thereby ensuring longer service lives of the first cam 5 and the first driving assembly 3.

The protruding part 52 of the first cam 5 abuts against the abutting part 332 of the second cam 33 via the rolling wheel 335.

In some examples, the axis line of the rolling wheel 335 is approximately parallel to the contact surface between the protruding part 52 and the first driving assembly 3, thereby ensuring that the rolling wheel 335 can stably roll on the first cam 5.

According to another aspect of the present disclosure, a cleaning device 10 is provided. The cleaning device 10 includes the transmission apparatus described above.

In some embodiments provided by the present disclosure, the cleaning device 10 further includes a first housing 6. The first housing 6 is connected to the main body of the cleaning device 10. The first housing 6 is disposed on one side of the cleaning device 10 that is adjacent to the surface to be cleaned. The telescopic driving member 31 and the swing arm 2 are located outside the first housing 6. The transmission gear 32, the second cam 33, the first cam 5, and the elastic member 4 are all located within the first housing 6. The transmission gear 32 passes through the first housing 6 and is drivingly connected to the telescopic driving member 31. One end of the elastic member 4 is connected to the first housing 6, and the other end of the elastic member 4 is connected to the first cam 5.

The transmission gear 32, the second cam 33, the first cam 5, and the elastic member 4 are all located within the first housing 6. Therefore, the first housing 6 is used to well protect the transmission apparatus, which is beneficial to prolonging the service life and reliability of the transmission apparatus and ensuring good transmission precision of the transmission apparatus.

In some examples, the first housing 6 may include a first upper housing and a first lower housing that are detachably connected, thereby facilitating disassembly and assembly of the first housing 6, facilitating disassembly and assembly of the first driving assembly 3, and facilitating disassembly and assembly of the transmission apparatus. In some examples, the first upper housing and the first lower housing may be detachably connected through at least one of a screw, a snap-fit structure, a mortise-and-tenon structure, and/or a magnetic attraction structure.

In some embodiments provided by the present disclosure, the cleaning device 10 further includes a position detection apparatus 7. The position detection apparatus 7 is disposed within the housing and is configured to detect the rotation position of the second cam 33. The telescopic driving member 31 rotates or stops rotating based on the detection result of the position detection apparatus 7.

By providing the position detection apparatus 7, the rotation position of the second cam 33 can be detected, and thus the rotation position of the first cam 5 can be known. Therefore, when the first cam 5 rotates to an appropriate position, for example, when the first cam 5 rotates to drive, through the swing arm 2, the rotary cleaning unit 1 to move to the first position or the second position, the telescopic driving member 31 stops rotating based on the detection result of the position detection apparatus 7 at this time, such that the rotary cleaning unit 1 can be maintained at the first position or the second position, so as to achieve accurate switching between the first position and the second position. It can be understood that, when the first cam 5 rotates, and the rotary cleaning unit 1 does not move to the first position or the second position under the driving of the swing arm 2, the telescopic driving member 31 may continue to rotate based the detection result of the position detection apparatus 7 at this time, so as to drive the rotary cleaning unit 1 to continue to move towards a direction adjacent to a target operation position (for example, the first position or the second position).

The position detection apparatus 7 may include a photoelectric switch, a mechanical switch, or other detection mechanisms that meet the requirements.

In the above embodiments, the position detection apparatus 7 includes a first photoelectric switch 71 and a second photoelectric switch 72 that are disposed on both sides of the second cam 33. The second cam 33 further includes a first baffle 333 and a second baffle 334 that are disposed on both sides of the abutting part 332. The first baffle 333 is adapted to be inserted into the first photoelectric switch 71 to cause the first photoelectric switch 71 to change the detection signal. The second baffle 334 is adapted to be inserted into the second photoelectric switch 72 to cause the second photoelectric switch 72 to change the detection signal.

In this embodiment, the first photoelectric switch 71 and the second photoelectric switch 72 are respectively disposed on both sides of the second cam 33, such that the two photoelectric switches are used to respectively perform position detection on whether the rotary cleaning unit 1 reaches the first position and the second position. Therefore, the accuracy of detecting whether the rotary cleaning unit 1 reaches the target operation position can be improved.

The photoelectric switch generally includes a light emitting part and a light receiving part. The light receiving part changes the detection signal of the photoelectric switch based on whether an optical signal from the light emitting part can be received. By providing the first baffle 333 and the second baffle 334 on the second cam 33, the rotation of the second cam 33 can drive the first baffle 333 and the second baffle 334 to rotate synchronously. The first baffle 333 and the second baffle 334 are disposed on both sides of the abutting part 332. When the second cam 33 rotates to an appropriate position, the first baffle 333 is inserted into the first photoelectric switch 71 to cause the first photoelectric switch 71 to change the detection signal. For example, the first baffle 333 is located between the light emitting part and the light receiving part of the first photoelectric switch 71 to prevent the light receiving part from receiving the optical signal emitted by the light emitting part, such that the first photoelectric switch 71 changes the detection signal, indicating that the first cam 5 rotates to an appropriate position, thereby placing the rotary cleaning unit 1 at the first position. In this case, the telescopic driving member 31 may stop rotating based on the detection signal of the first photoelectric switch 71, so as to maintain the rotary cleaning unit 1 at the first position.

When the second cam 33 rotates to an appropriate position, the second baffle 334 is inserted into the second photoelectric switch 72 to cause the second photoelectric switch 72 to change the detection signal. For example, the second baffle 334 is located between the light emitting part and the light receiving part of the second photoelectric switch 72 to prevent the light receiving part from receiving the optical signal emitted by the light emitting part, such that the second photoelectric switch 72 changes the detection signal until the first cam 5 rotates to an appropriate position, thereby placing the rotary cleaning unit 1 at the second position. In this case, the telescopic driving member 31 may stop rotating based on the detection signal of the second photoelectric switch 72, so as to maintain the rotary cleaning unit 1 at the second position.

In some embodiments provided by the present disclosure, the cleaning device 10 further includes a rotation angle detection apparatus. The rotation angle detection apparatus is disposed on the telescopic driving member 31 and is configured to detect the rotation angle of the output shaft of the telescopic driving member 31. The telescopic driving member 31 further rotates or stops rotating based on the detection result of the rotation angle detection apparatus.

By providing the rotation angle detection apparatus, the rotation angle of the output shaft of the telescopic driving member 31 can be detected. As a result, the rotation angle of the transmission gear 32 and the rotation angle of the second cam 33 can be known, and further, the rotation angle of the first cam 5 can be known. Therefore, when the first cam 5 rotates to an appropriate angle, for example, when the first cam 5 rotates to drive, through the swing arm 2, the rotary cleaning unit 1 to move to the first position or the second position, the telescopic driving member 31 stops rotating based on the detection result of the rotation angle detection apparatus at this time, such that the rotary cleaning unit 1 can be maintained at the first position or the second position, so as to achieve accurate switching between the first position and the second position. It can be understood that, when the first cam 5 rotates, and, the rotary cleaning unit 1 does not move to the first position or the second position under the driving of the swing arm 2, the telescopic driving member 31 may continue to rotate based on the detection result of the rotation angle detection apparatus at this time, so as to drive the rotary cleaning unit 1 to continue to move towards a direction adjacent to a target operation position (for example, the first position or the second position).

In some embodiments provided by the present disclosure, a first limiting member 8 and a second limiting member 9 are further provided within the first housing 6, which are disposed on the circumferential side of the first cam 5. The first limiting member 8 is located on one side of the protruding part 52 that is away from the abutting part 332. The first limiting member 8 is configured to abut against the protruding part 52 to limit the rotation of the first cam 5. The second limiting member 9 is located on one side of the connecting part 51 that is away from the abutting part 332. The second limiting member 9 is configured to abut against the connecting part 51 to limit the rotation of the first cam 5.

Therefore, the rotation of the first cam 5 can be limited. For example, after the first cam 5 rotates to an appropriate position, the protruding part 52 of the first cam 5 abuts against the first limiting member 8, and thus the first cam 5 does not continue to move towards the direction adjacent to the first limiting member 8, such that the rotary cleaning unit 1 can be reliably and accurately maintained at the first position. Meanwhile, after the first cam 5 rotates to an appropriate position, the connecting part 51 of the first cam 5 abuts against the second limiting member 9, and thus the first cam 5 does not continue to move towards the direction adjacent to the second limiting member 9, such that the rotary cleaning unit 1 can be reliably and accurately maintained at the second position.

It can be understood that, in such a state, even if the telescopic driving member 31 continues to rotate, the first cam 5 does not continue to rotate under the action of the first limiting member 8 or the second limiting member 9. Therefore, even when the position detection apparatus 7 and the rotation angle detection apparatus malfunction, the rotary cleaning unit 1 can still be reliably maintained at the first position or the second position, thereby achieving double confirmation and improving the accuracy and reliability of the rotary cleaning unit 1 in reaching the target operation position.

In some embodiments of the present disclosure, the cleaning device 10 further includes a second driving assembly 11. The second driving assembly 11 is connected to the rotary cleaning unit 1 and is configured to drive the rotary cleaning unit 1 to ascend or descend.

The second driving assembly 11 is further configured to drive the rotary cleaning unit 1 to vibrate and/or rotate with the central axis of the rotary cleaning unit as the rotation center.

Therefore, the second driving assembly 11 may be used to drive the rotary cleaning unit 1 at the first position or the second position to descend to be in contact with the surface to be cleaned and rotate, so as to achieve a mopping operation on the surface to be cleaned. After a cleaning operation is completed, the second driving assembly 11 is used to drive the rotary cleaning unit 1 to ascend, such that the rotary cleaning unit 1 can be separated from the surface to be cleaned, and when the rotary cleaning unit 1 is accommodated, the rotary cleaning unit 1 is not in contact with the surface to be cleaned during the process in which the cleaning device 10 moves. Therefore, in scenarios where mopping is not needed, for example, when the cleaning device 10 travels back and forth to the base station or performs carpet cleaning, the rotary cleaning unit 1 is prevented from contacting the surface to be cleaned and causing secondary contamination of the surface to be cleaned, which is beneficial to improving the cleaning performance of the automatic cleaning device 10, and improving the cleaning efficiency and use experience.

That is, the second driving assembly 11 may drive the lifting or lowering operation and the rotation operation of the rotary cleaning unit 1 according to the requirement of whether the rotary cleaning unit 1 needs to be in contact with the surface to be cleaned, i.e., whether the rotary cleaning unit 1 needs to perform the cleaning function or the accommodation function, so as to meet different functional requirements of the rotary cleaning unit 1. In other words, a differentiation strategy between cleaning and accommodation of the rotary cleaning unit 1 can be implemented, thereby improving the cleaning performance of the cleaning device 10. It can be understood that, when the rotary cleaning unit 1 is at the first position, both the cleaning function and the accommodation function can be implemented. When the rotary cleaning unit 1 is at the second position, both the cleaning function and the accommodation function can be implemented.

The second driving assembly 11 is further configured to drive the rotary cleaning unit 1 to vibrate, for example, to vibrate in the horizontal direction, which can further improve the cleaning effect.

Therefore, the cleaning device 10 provided by the embodiments of the present disclosure utilizes the first driving assembly 3 to drive the rotary cleaning unit 1 to switch between the first position and the second position, and utilizes the second driving assembly 11 to drive the rotary cleaning unit 1 to ascend or descend, vibrate, and rotate. Through cooperation of the first driving assembly 3 and the second driving assembly 11, wet cleaning operations for different wet cleaning ranges can be satisfied, thereby expanding the cleaning range of the cleaning device 10 and improving the cleaning effect. Meanwhile, the requirement of whether the rotary cleaning unit 1 needs to be in contact with the surface to be cleaned can be satisfied, that is, different functional requirements of cleaning or accommodation of the rotary cleaning unit 1 can be satisfied, thereby improving the cleaning performance of the cleaning device 10 and improving the user experience.

In this embodiment, one second driving assembly 11 is used to drive the lifting or lowering and rotation of the rotary cleaning unit 1. Compared to the related art in which two second driving assemblies are required to respectively drive the lifting or lowering and rotation of a cleaning element, the configuration is simplified by using one driving assembly. Therefore, the design requirements for a compact structure and a small volume of the cleaning device 10 can be satisfied, which is beneficial to reducing the space occupied by the cleaning device 10 and reducing the cost, and is suitable for popularization and application.

In some embodiments provided by the present disclosure, the second driving assembly 11 includes: a lifting/lowering driving part 111, and a connecting apparatus 112. At least part of the connecting apparatus 112 is disposed within the swing arm 2 and connected to the rotary cleaning unit 1. The lifting/lowering driving part 111 drives the rotary cleaning unit 1 to ascend or descend and rotate via the connecting apparatus 112.

In this embodiment, since the connecting apparatus 112 is connected to the swing arm 2 and the rotary cleaning unit 1, the connecting apparatus 112 can drive the rotary cleaning unit 1 to ascend or descend and rotate under the action of the lifting/lowering driving part 111, and can drive the rotary cleaning unit 1 to switch between the first position and the second position under the action of the swing arm 2.

In some embodiments provided by the present disclosure, the connecting apparatus 112 includes:
a lifting/lowering driving part 111 and a connecting apparatus 112. At least part of the connecting apparatus 112 is disposed within the swing arm 2 and connected to the rotary cleaning unit 1. The lifting/lowering driving part 111 drives the rotary cleaning unit 1 to ascend or descend and rotate via the connecting apparatus 112.

Therefore, the power of the lifting/lowering driving part 111 is transmitted to a gear set 1122 through a worm 1121, and a sleeve 1123 is driven to ascend or descend and rotate via the gear set 1122, such that the rotary cleaning unit 1 is driven to ascend or descend and rotate. The worm 1121 cooperates with the gear set 1122, and the mechanical structure thereof is compact with a small volume and accurate transmission, which is beneficial to reducing the volume of the connecting apparatus 112, thereby reducing the volume of the second driving assembly 11, and satisfying the design requirements for a compact structure and a small volume of the cleaning device 10.

In the above embodiments, the gear set 1122 includes:
a worm wheel 11221, a first sub-gear 11222, a second sub-gear, a third sub-gear 11225, and a connecting drum 11226.

The worm wheel 11221 and the first sub-gear 11222 are coaxially arranged. The worm wheel 11221 is located outside the swing arm 2 and engaged with the worm 1121. The first sub-gear 11222, the second sub-gear, and the third sub-gear 11225 are all located inside the swing arm 2. The second sub-gear includes a first gear disc 11223 and a second gear disc 11224 that are coaxially arranged. The first sub-gear 11222 is engaged with the first gear disc 11223. The second gear disc 11224 is engaged with the third sub-gear 11225. The connecting drum 11226 is coaxially arranged with the third sub-gear 11225 and located outside the swing arm 2. The connecting drum 11226 is threadedly connected to the sleeve 1123. The gear set 1122 rotates to cause the sleeve 1123 and the connecting drum 11226 to rotate relative to each other, so as to drive the sleeve 1123 to ascend or descend relative to the connecting drum 11226.

Therefore, the lifting/lowering driving part 111 rotates to drive the worm 1121 to rotate. Since the worm wheel 11221 is engaged with the worm 1121, the worm wheel 11221 is driven to rotate, thereby driving the first sub-gear 11222 coaxially arranged with the worm wheel 11221 to rotate. Since the first sub-gear 11222 is engaged with the first gear disc 11223, the first gear disc 11223 and the second gear disc 11224 coaxially arranged with the first gear disc 11223 are driven to rotate. Since the second gear disc 11224 is engaged with the third sub-gear 11225, the third sub-gear 11225 is driven to rotate, thereby driving the connecting drum 11226 coaxially arranged with the third sub-gear 11225 to rotate. Since the connecting drum 11226 and the sleeve 1123 are threadedly connected, the sleeve 1123 and the connecting drum 11226 rotate relative to each other to drive the sleeve 1123 to ascend or descend relative to the connecting apparatus 112, thereby driving the rotary cleaning unit 1 mounted within the sleeve 1123 to ascend or descend and rotate. Such configuration has a simple structure and provides high transmission precision.

The first sub-gear 11222, the second sub-gear, and the third sub-gear 11225 are all located inside the swing arm 2. Therefore, the swing arm 2 is used to provide mounting space and a certain protection for the first sub-gear 11222, the second sub-gear, and the third sub-gear 11225, which can prolong the service lives of the first sub-gear 11222, the second sub-gear, and the third sub-gear 11225, thereby improving the reliability of the second driving assembly 11. Meanwhile, the design requirements for a compact structure and a small volume of the first cleaning assembly can be satisfied. It can be understood that the rotation shaft connecting the first sub-gear 11222 and the worm wheel 11221 passes through the swing arm 2, and the rotation shaft connecting the third sub-gear 11225 and the connecting drum 11226 passes through the swing arm 2, such that the power of the lifting/lowering driving part 111 is transmitted from the exterior of the swing arm 2 to the interior of the swing arm 2 through the worm 1121 and the worm wheel 11221, and then transmitted to the exterior of the swing arm 2 again through the connecting drum 11226, such that the rotary cleaning unit 1 is driven to ascend or descend and rotate via the sleeve 1123.

In some embodiments provided by the present disclosure, the drum wall of the connecting drum 11226 is provided with a guiding part 11227 that is arranged in a spiral direction; the sleeve wall of the sleeve 1123 is provided with an insertion groove 11231 configured to accommodate the connecting drum 11226, and the groove wall of the insertion groove 11231 is provided with a spiral guiding groove 11232 configured to accommodate the guiding part 11227.

In this embodiment, the top end of the sleeve 1123 is provided with an insertion groove 11231. The insertion groove 11231 of the sleeve 1123 is inserted into the drum wall of the connecting drum 11226, and the guiding part 11227 on the drum wall of the connecting drum 11226 is accommodated within the guiding groove 11232 of the insertion groove 11231. Since the guiding part 11227 is arranged in a spiral shape, and the guiding groove 11232 is in a spiral shape, the guiding part 11227 moves along the guiding groove 11232 in a spiral shape, which enables the rotation, lifting, and lowering of the sleeve 1123 relative to the connecting drum 11226. That is, the connection manner of the sleeve 1123 and the connecting drum 11226 may be regarded as the connection manner of a lead screw nut. Such configuration has a simple structure and is easy to implement, and enables the lifting and lowering and rotation of the sleeve 1123 by utilizing one set of structures, which is beneficial to reducing the volume of the second driving assembly 11.

Further, the guiding part 11227 is disposed on the outer wall of the connecting drum 11226, and the guiding groove 11232 is disposed on the groove wall of the insertion groove 11231 that is away from the interior of the sleeve 1123. Alternatively, the guiding part 11227 is disposed on the inner wall of the connecting drum 11226, and the guiding groove 11232 is disposed on the groove wall of the insertion groove 11231 that is adjacent to the interior of the sleeve 1123.

The guiding part 11227 is a spiral boss. For example, the guiding part 11227 is an outwardly protruding thread. Therefore, this is beneficial to improving the accuracy and reliability of mutual limiting and guiding between the guiding part 11227 and the guiding groove 11232, thereby improving the stability of the lifting or lowering and rotation of the sleeve 1123 relative to the connecting drum 11226.

Alternatively, the guiding part 11227 is a plurality of protrusions that are spaced apart from each other, that is, the plurality of protrusions are spaced apart from each other in a spiral shape. Therefore, the structure of the guiding part 11227 can be simplified, which is beneficial to reducing material consumption of the guiding part 11227 and saving the manufacturing cost. In some examples, the number of the protrusions may be two, three, four, or other numbers.

In some embodiments provided by the present disclosure, a retaining rib is provided at a position, adjacent to the opening, of the groove wall of the insertion groove 11231. The retaining rib is configured to abut against the guiding part 11227 to limit lifting/lowering movement of the sleeve 1123 relative to the connecting drum 11226. That is, the retaining rib cooperates with the guiding part 11227 to limit the extreme descending position of the sleeve 1123 relative to the connecting drum 11226. Therefore, the guiding part 11227 can be prevented from detaching from the guiding groove 11232 to cause the sleeve 1123 to be separated from the connecting drum 11226, thereby enabling the sleeve 1123 to be reliably connected to the connecting drum 11226. Meanwhile, the rotary cleaning unit 1 connected to the sleeve 1123 can be reliably and fully in contact with the surface to be cleaned.

The guiding part 11227 abuts against the groove bottom of the insertion groove 11231 to limit the lifting/lowering movement of the sleeve 1123 relative to the connecting drum 11226. That is, the guiding part 11227 cooperates with the groove bottom of the insertion groove 11231 to limit the extreme ascending position of the sleeve 1123 relative to the connecting drum 11226, so as to prevent the rotary cleaning unit 1 from continuously ascending after reaching the extreme position and thus damaging the second driving assembly 11, thereby improving the operating reliability of the cleaning device 10. Meanwhile, a certain distance is maintained between the rotary cleaning unit 1 at the extreme ascending position and the surface to be cleaned, so as to reduce the impact on climbing and obstacle-crossing of the cleaning device 10, and the impact of secondary contamination to the surface to be cleaned.

In some embodiments provided by the present disclosure, the inner wall of the sleeve 1123 is provided with a limiting plane 11233 matching the rotary cleaning unit 1. The arrangement of the limiting plane 11233 can ensure that the rotary cleaning unit 1 rotates together with the rotation of the sleeve 1123, so as to ensure a good cleaning capability of the rotary cleaning unit 1.

The axial cross-section of the sleeve 1123 is hexagonal, that is, the inner wall of the sleeve 1123 is provided with six planes. It can be understood that the six planes may all be limiting planes 11233, or some of the six planes are limiting planes 11233. In some examples, a portion of the rotary cleaning unit 1 connected to the sleeve 1123 may be configured as a hexagonal prism structure. Therefore, the hexagonal prism structure cooperates with the six planes of the inner wall of the sleeve 1123 to limit the rotation of the rotary cleaning unit 1 relative to the sleeve 1123. This results in a simple structure, ease of processing, and reliable limiting.

In some embodiments provided by the present disclosure, the second driving assembly 11 further includes a second housing 113 having an opening at one end. When the cleaning device 10 includes the first housing 6, the second housing 113 is snap-fitted to the first housing 6; the worm 1121, the worm wheel 11221, the swing arm 2, and the connecting drum 11226 are located within a space enclosed by the second housing 113 and the first housing 6; the opening of the second housing 113 is located on one side away from the first housing 6; the bottom end of the sleeve 1123 is adapted to extend out of the opening of the second housing 113; the lifting/lowering driving part 111 is located outside the second housing 113; and the worm 1121 passes through the second housing 113 and is connected to the lifting/lowering driving part 111.

The bottom end of the sleeve 1123 is adapted to extend out of the opening of the second housing 113, so as to ensure that the rotary cleaning unit 1 connected to the sleeve 1123 can descend to be in contact with the surface to be cleaned. Meanwhile, a certain distance can be maintained between the bottom end of the second housing 113 and the surface to be cleaned, so as to avoid the impact of the second housing 113 on climbing and obstacle-crossing of the cleaning device 10.

The lifting/lowering driving part 111 is located outside the second housing 113. The worm 1121 passes through the second housing 113 and is connected to the lifting/lowering driving part 111. Therefore, the power of the lifting/lowering driving part 111 can be transmitted from the exterior of the second housing 113 to the interior of the second housing 113.

In the above embodiments, the second housing 113 is partitioned into a first mounting cavity 1131 and a second mounting cavity 1132. The worm wheel 11221 is located within the first mounting cavity 1131. The sleeve 1123 is located within the second mounting cavity 1132. The swing arm 2 extends to the first mounting cavity 1131 and the second mounting cavity 1132. The first sub-gear 11222 within the swing arm 2 is coaxially arranged with the worm wheel 11221 within the first mounting cavity 1131. The sleeve 1123 within the second mounting cavity 1132 is connected to the connecting drum 11226 on the swing arm 2. Therefore, the power of the lifting/lowering driving part 111 can be transmitted to the sleeve 1123 through the first mounting cavity 1131 and the second mounting cavity 1132, so as to drive the rotary cleaning unit 1 to ascend or descend and rotate.

The second mounting cavity 1132 has a shape adapted to the motion space of the swing arm 2. Therefore, the cavity wall of the second mounting cavity 1132 does not hinder the motion of the swing arm 2. Meanwhile, the swing arm 2 is well protected, and the volume of the second driving assembly 11 is reduced as much as possible, so as to satisfy the design requirements for a compact structure and a small volume of the first cleaning assembly.

The second housing 113 further includes a bottom plate 1133. The bottom plate 1133 is detachably connected to the cavity wall of the first mounting cavity 1131 to enclose the worm wheel 11221 within the first mounting cavity 1131. The arrangement of the bottom plate 1133 provides good protection for the worm wheel 11221, and can reduce contamination of the worm wheel 11221 by a dirty fluid. Therefore, the service life of the worm wheel 11221 can be prolonged, and the reliability of the second driving assembly 11 can be improved.

In some examples, the bottom plate 1133 may be detachably connected to the cavity wall of the first mounting cavity 1131, through a screw, a snap-fit structure, a mortise-and-tenon structure, a magnetic structure, or the like.

The embodiments of the present disclosure above provide a transmission apparatus and a cleaning device 10. One end of the swing arm 2 is rotatably connected to the main body of the cleaning device 10, and the other end of the swing arm 2 is connected to the rotary cleaning unit 1, such that the cleaning device 10 employing the aforementioned transmission apparatus has a mopping disc extending and retracting function. According to a cleaning range requirement, the swing arm 2 is used to drive the rotary cleaning unit 1 to switch between the first position and the second position, so as to move the rotary cleaning unit 1 to an operating position that meets the corresponding cleaning range requirement, such that requirements of different mopping ranges are met and the mopping range is expanded, which is beneficial to improving the cleaning effect, thereby improving the cleaning experience of the user. Meanwhile, when the rotary cleaning unit 1 moves from the first position towards the second position, the rotation direction of the swing arm 2 is the same as the rotation direction of the rotary cleaning unit 1, such that a torque generated due to friction between the rotary cleaning unit 1 and a surface to be cleaned becomes an assisting force for the rotary cleaning unit 1 to retract. Therefore, the rotary cleaning unit 1 can be easily retracted when being in contact with an obstacle, such that a passive posture change of the cleaning device 10 when the rotary cleaning unit 1 is blocked by the obstacle can be avoided; and thus the cleaning device 10 can perform cleaning tightly against the boundary of the obstacle, such that the cleaning device 10 is able to operate in a complex environment, thereby improving the application range of the cleaning device 10.

Those skilled in the art can easily understand that the above advantageous methods can be freely combined and superimposed on the premise of no conflict.

The above descriptions are merely preferred embodiments of the present disclosure, and are not intended to limit the present disclosure. Any modifications, equivalent substitutions, improvements, and the like that are made within the spirit and principle of the present disclosure should be included in the protection scope of the present disclosure. The above descriptions are merely preferred embodiments of the present disclosure. It should be noted that, for those of ordinary skill in the art, several improvements and variations may also be made without departing from the technical principle of the present disclosure, and such improvements and variations should be also regarded as falling within the protection scope of the present disclosure.

1. A transmission apparatus, applied to a cleaning device, the transmission apparatus comprising a swing arm and a rotary cleaning unit, wherein one end of the swing arm is rotatably connected to a main body of the cleaning device, the other end of the swing arm is connected to the rotary cleaning unit, and the swing arm is configured to drive the rotary cleaning unit to move between a first position and a second position;
an area of at least part of the rotary cleaning unit located outside a projection region of the cleaning device when the rotary cleaning unit is located at the second position is larger than an area of at least part of the rotary cleaning unit located outside the projection region of the cleaning device when the rotary cleaning unit is located at the first position, and a rotation direction of the swing arm is the same as a rotation direction of the rotary cleaning unit when the rotary cleaning unit moves from the first position towards the second position.

2. The transmission apparatus according to claim 1, wherein the rotation direction of the swing arm and the rotation direction of the rotary cleaning unit are clockwise; or
the rotation direction of the swing arm and the rotation direction of the rotary cleaning unit are counterclockwise.

3. The transmission apparatus according to claim 1, further comprising a first driving assembly and an elastic member, wherein the elastic member is connected to the swing arm, and the first driving assembly is configured to cooperate with the elastic member to cause the swing arm to rotate, so as to drive the rotary cleaning unit to move between the first position and the second position.

4. The transmission apparatus according to claim 3, wherein a first end of the elastic member is connected to the swing arm, and a second end of the elastic member is fixed relative to the main body of the cleaning device.

5. The transmission apparatus according to claim 4, further comprising a first cam, wherein the first cam is disposed at one end of the swing arm that is away from the rotary cleaning unit, and the first driving assembly abuts against a protruding part of the first cam during a progress in which the rotary cleaning unit moves from the second position towards the first position.

6. The transmission apparatus according to claim 5, wherein the elastic member is a tension spring, a first end of the tension spring is connected to the first cam, and a second end of the tension spring is fixed relative to the main body of the cleaning device; or
the elastic member is a torsion spring, the torsion spring is disposed at a rotation shaft of the first cam, a first end of the torsion spring is connected to the first cam, and a second end of the torsion spring is fixed relative to the main body of the cleaning device; or
the elastic member is an elastic plate, a first end of the elastic plate is connected to the first cam, and a second end of the elastic plate is fixed relative to the main body of the cleaning device.

7. The transmission apparatus according to claim 5, wherein the first end of the elastic member is connected to the first cam; and/or
the first end of the elastic member is connected to the swing arm; and/or
a circumferential side of the first cam is provided with a connecting part, and the elastic member is connected to the first cam through the connecting part; and/or
the rotary cleaning unit moves from the second position towards the first position when the first cam rotates in a first direction under driving of the first driving assembly; and/or
the rotary cleaning unit moves from the first position towards the second position when the first cam rotates in a second direction under an action of the elastic member; and/or
wherein when the rotary cleaning unit moves from the second position towards the first position, the elastic member accumulates elastic potential energy under driving of the first driving assembly; and/or
elastic potential energy of the elastic member is released when the rotary cleaning unit moves from the first position towards the second position; and/or
the first driving assembly comprises a first driving part and a second cam, the first driving part is connected to the second cam and is configured to drive the second cam to rotate, and the second cam abuts against the first cam to drive the first cam to rotate.

8. The transmission apparatus according to claim 7, wherein the second cam is disposed on an output end of the first driving part, such that the first driving part drives the second cam to rotate; or
an output end of the first driving part is in transmission connection with the second cam.

9. The transmission apparatus according to claim 7, wherein the second cam comprises a sector gear part and an abutting part, the first driving part is engaged with the sector gear part, the abutting part abuts against the first cam, and the first cam is coaxially arranged with the swing arm; and/or
the first driving part comprises a telescopic driving member and a transmission gear, the telescopic driving member is connected to the transmission gear, and the transmission gear is engaged with the sector gear part, such that the telescopic driving member drives, via the transmission gear and the sector gear part, the abutting part to push the first cam to rotate, and the rotary cleaning unit is driven to move from the second position towards the first position through synchronous rotation of the swing arm; and/or
when the rotary cleaning unit is at the second position, the second cam is separated from the first cam; and/or
outer walls of the first cam and the second cam are provided with wear-resistant layers; and/or
the second cam is provided with a rolling wheel, and the second cam abuts against the first cam via the rolling wheel.

10. A cleaning device, comprising:
a transmission apparatus comprising a swing arm and a rotary cleaning unit, wherein one end of the swing arm is rotatably connected to a main body of the cleaning device, the other end of the swing arm is connected to the rotary cleaning unit, and the swing arm is configured to drive the rotary cleaning unit to move between a first position and a second position;
an area of at least part of the rotary cleaning unit located outside a projection region of the cleaning device when the rotary cleaning unit is located at the second position is larger than an area of at least part of the rotary cleaning unit located outside the projection region of the cleaning device when the rotary cleaning unit is located at the first position, and a rotation direction of the swing arm is the same as a rotation direction of the rotary cleaning unit when the rotary cleaning unit moves from the first position towards the second position.

11. The cleaning device according to claim 10, the cleaning device comprising a first housing; the telescopic driving member and the swing arm are located outside the first housing; the transmission gear, the second cam, the first cam, and the elastic member are located within the first housing; the transmission gear passes through the first housing and is drivingly connected to the telescopic driving member; and one end of the elastic member is connected to the first housing, and the other end of the elastic member is connected to the first cam.

12. The cleaning device according to claim 11, further comprising:
a position detection apparatus,
wherein the position detection apparatus being disposed within the first housing and configured to detect a rotation position of the second cam, wherein the telescopic driving member rotates or stops rotating based on a detection result of the position detection apparatus; and/or
wherein the position detection apparatus comprises a first photoelectric switch and a second photoelectric switch that are disposed on both sides of the second cam, and the second cam further comprises a first baffle and a second baffle that are disposed on both sides of the abutting part, the first baffle being adapted to be inserted into the first photoelectric switch to cause the first photoelectric switch to change a detection signal, and the second baffle being adapted to be inserted into the second photoelectric switch to cause the second photoelectric switch to change the detection signal.

13. The cleaning device according to claim 10, further comprising:
a rotation angle detection apparatus, disposed on the telescopic driving member and configured to detect a rotation angle of an output shaft of the telescopic driving member, wherein the telescopic driving member further rotates or stops rotating based on a detection result of the rotation angle detection apparatus; and/or
wherein the circumferential side of the first cam is provided with a first limiting member and a second limiting member; the first limiting member is located on one side of the protruding part that is away from the abutting part; the first limiting member is configured to abut against the protruding part to limit rotation of the first cam; the second limiting member is located on one side of the connecting part that is away from the abutting part; and the second limiting member is configured to abut against the connecting part to limit the rotation of the first cam.

14. The cleaning device according to claim 12, the cleaning device further comprising a second driving assembly,
wherein the second driving assembly is connected to the rotary cleaning unit and configured to drive the rotary cleaning unit to ascend or descend; and/or
wherein the second driving assembly is further configured to drive the rotary cleaning unit to vibrate and/or rotate with a central axis of the rotary cleaning unit as a rotation center; and/or
wherein the second driving assembly comprises: a lifting/lowering driving part and a connecting apparatus, at least part of the connecting apparatus is disposed within the swing arm and connected to the rotary cleaning unit, and the lifting/lowering driving part drives the rotary cleaning unit to ascend or descend and rotate via the connecting apparatus.

15. The cleaning device according to claim 14, wherein the connecting apparatus comprises:
a worm, a gear set, and a sleeve that are drivingly connected; the worm is drivingly connected to the lifting/lowering driving part; the gear set is disposed within the swing arm; the sleeve is connected to the rotary cleaning unit; and the worm drives, via the gear set, the sleeve to ascend or descend and rotate to drive the rotary cleaning unit to ascend or descend and rotate.

16. The cleaning device according to claim 15, the gear set comprising:
a worm wheel, a first sub-gear, a second sub-gear, a third sub-gear, and a connecting drum,
wherein,
the worm wheel and the first sub-gear are coaxially arranged; the worm wheel is located outside the swing arm and engaged with the worm; the first sub-gear, the second sub-gear, and the third sub-gear are all located inside the swing arm; the second sub-gear comprises a first gear disc and a second gear disc that are coaxially arranged; the first sub-gear is engaged with the first gear disc; the second gear disc is coaxially arranged on the first gear disc and engaged with the third sub-gear; the connecting drum is coaxially arranged with the third sub-gear and located outside the swing arm; the connecting drum is threadedly connected to the sleeve; and the gear set rotates to cause the sleeve and the connecting drum to rotate relative to each other, so as to drive the sleeve to ascend or descend relative to the connecting drum.

17. The cleaning device according to claim 16, wherein a drum wall of the connecting drum is provided with a guiding part that is arranged in a spiral direction;
a sleeve wall of the sleeve is provided with an insertion groove configured to accommodate the connecting drum, and a groove wall of the insertion groove is provided with a spiral guiding groove configured to accommodate the guiding part; and
the guiding part is a spiral boss, or a plurality of protrusions that are spaced apart from each other.

18. The cleaning device according to claim 17, wherein a retaining rib is provided at a position, adjacent to an opening, of the groove wall of the insertion groove, the retaining rib being configured to abut against the guiding part to limit lifting/lowering movement of the sleeve relative to the connecting drum; and
the guiding part abuts against a groove bottom of the insertion groove to limit the lifting/lowering movement of the sleeve relative to the connecting drum.

19. The cleaning device according to claim 18, wherein an inner wall of the sleeve is provided with a limiting plane matching the rotary cleaning unit, and an axial cross-section of the sleeve is hexagonal; and/or
wherein the second driving assembly further comprises a second housing having an opening at one end; when the cleaning device comprises the first housing, the second housing is snap-fitted to the first housing; the worm, the worm wheel, the swing arm, and the connecting drum are located within a space enclosed by the second housing and the first housing; the opening of the second housing is located on one side away from the first housing; a bottom end of the sleeve is adapted to extend out of the opening of the second housing; the lifting/lowering driving part is located outside the second housing; and the worm passes through the second housing and is connected to the lifting/lowering driving part.

20. The cleaning device according to claim 19, wherein the second housing is partitioned into a first mounting cavity and a second mounting cavity, the worm wheel is located within the first mounting cavity, the sleeve is located within the second mounting cavity, the swing arm extends to the first mounting cavity and the second mounting cavity, and the second mounting cavity has a shape adapted to a motion space of the swing arm; and the second housing further comprises a bottom plate, and the bottom plate is detachably connected to a cavity wall of the first mounting cavity to enclose the worm wheel within the first mounting cavity.
